(19) United States
(12) Patent Application Publication
(10) Pub. No.: US 2020/0016810 A1
(43) Pub. Date: Jan. 16, 2020

(54) SYSTEMS AND METHODS FOR PRODUCING ELECTRIC CANDLES OR THEIR COMPONENTS

(71) Applicant: Luminara Worldwide, LLC, Eden Prairie, MN (US)

(72) Inventor: Douglas Patton, Eden Prairie, MN (US)

(21) Appl. No.: 16/335,960

(22) PCT Filed: Oct. 2, 2017
(86) PCT No.: PCT/US2017/054795

§ 371 Date: Mar. 22, 2019

Related U.S. Application Data
(60) Provisional application No. 62/473,141, filed on Mar. 17, 2017.
(60) Provisional application No. 62/402,250, filed on Sep. 30, 2016.

(51) Int. Cl. B29C 45/26; B29C 45/00; B29C 45/40; C08L 91/06; C08L 23/06; C08L 23/08; C08L 31/04; F21S 6/00; F21V 15/01

(52) U.S. Cl. CPC B29C 45/261; B29C 45/0001; B29C 45/40; C08L 91/06; B29K 2091/00; C08L 23/0853; C08L 31/04; F21S 6/001; F21V 15/01; C08L 23/06

(57) ABSTRACT

Various processes and compositions for producing wax or wax-like shells for electric candles and other lighting devices are described. Preferred processes utilize injection molding to produce the shells from a mixture of materials. The materials may be compounded before being heated and injected.

This application claims the benefit of priority to U.S. provisional application having Ser. No. 62/402250, filed on Sep. 30, 2016, and also claims the benefit of priority to U.S. provisional application having Ser. No. 62/473141, filed on Mar. 17, 2017. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is the manufacture of electric candles.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Various electric lights are known in the art. See, e.g., U.S. Pat. No. 8,132,936 to Patton et al., U.S. Pat. No. 8,070,319 to Schnuckle et al., U.S. Pat. No. 7,837,355 to Schnuckle et al., U.S. Pat. No. 7,261,455 to Schnuckle et al., U.S. Pat. No. 7,159,994 to Schnuckle et al., US 2011/0127914 to Patton et al., U.S. Pat. No. 7,350,720 to Jaworski et al.; US 2005/0285538 to Jaworski et al. (publ. December 2005); U.S. Pat. No. 7,481,571 to Bistritzky et al.; US 2008/0031784 to Bistritzky et al. (publ. February 2008); US 2006/0125420 to Boone et al. (publ. June 2006); US 2007/0127249 to Medley et al. (publ. June 2007); US 2008/0150453 to Medley et al. (publ. June 2008); US 2005/0169666 to Porchia, et al. (publ. August 2005); U.S. Pat. No. 7,503,668 to Porchia, et al.; U.S. Pat. No. 7,824,627 to Michaels, et al.; US 2006/0039835 to Nottingham et al. (publ. February 2006); US 2008/0038156 to Jaramillo (publ. February 2008); US 2008/0130266 to DeWitt et al. (publ. June 2008); US 2012/0024837 to Thompson (publ. February 2012); US 2011/0134628 to Pestl et al. (publ. June 2011); US 2011/0027124 to Albee et al. (publ. February 2011); US 2012/0020052 to McCavit et al. (publ. Jan. 2012); US 2012/0093491 to Browder et al. (publ. April 2012); and US 2014/0218903 to Sheng. However, all of these products suffer from one or more disadvantages or fail to disclose manufacturing systems and methods that result increased output at a reduced cost.

Currently, manufacturing wax shells, such as for electric candles, involves pouring wax liquid, pre-heated paraffin, into a cooking container and heating it to a desired temperature. Various additives can be added to the mixture for fragrance, color, etc. The liquid wax can then be poured into a container and heated. Once heated, the wax can be poured into molds, which may comprise metal tubes that define an outer perimeter of the wax shell. Cold water can be used to cool the molds by placing the molds or otherwise contacting the molds with the water. Once cooled and hardened, the wax shells can be removed from the molds. Next, a drilling machine is used to create a hole in the top of the wax shell. It is this laborsome process that increases the costs of the wax shells and necessitates manufacture outside of the U.S.

Although efforts have been made to improve the manufacturability of electric candles, see, e.g., U.S. 2016/0298055 to Patton et al. (publ. Oct. 13, 2016), more work is needed to bring down the time and cost to manufacture and assemble electric candles and other devices.

Thus, there is still a need for improved systems and methods for manufacturing electric candles and their related components.

### SUMMARY OF THE INVENTION

The inventive subject matter provides apparatus, systems and methods for the manufacture of electric candles or their components, and particularly, the injection molding of outer shells or housing for electric candles comprising wax or wax compositions.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a chart of different mixtures for producing wax or wax-like shells.

FIG. 2 is a perspective view of one embodiment of an injection molding machine.

FIG. 3 is a diagram of a plunger for use with injecting material into an injection molding machine.

FIG. 4A is a cross-section view of the machine of FIG. 2.

FIG. 4B is a cross-section view of the machine of FIG. 2 in an initial, open position.

FIG. 4C is a perspective view of the machine of FIG. 2 in a partially open position.

FIG. 4D is a cross-section view of the machine of FIG. 2 in a closed position.

FIGS. 4E-4F are cross-section views of the machine of FIG. 2 showing the mold being ejected.

FIGS. 5A-5B are cross-section and front views of a shell.

FIGS. 6A-6D are schematics of another embodiment of an injection molding machine.

FIGS. 7A-7D are various views of one embodiment of a shell produced having a molded insert.

FIGS. 8A-8 are various views of another embodiment of a shell produced having a molded insert.

FIGS. 9A-9C are various views of another embodiment of a shell produced having a molded insert.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventor evaluated various resins through multiple experiments to determine the process and materials that could be used to create outer shells for use in electric candles and other lighting devices. The goal was to identify the formulations that could be used in an injection molding process to create wax or wax-like shells and replace the traditional method for forming wax candle shells for electric candles.

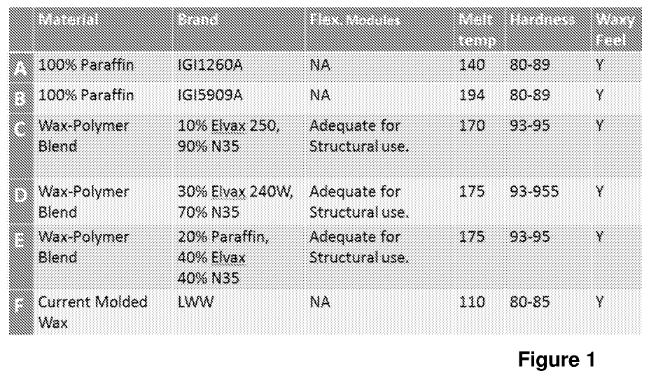

FIG. 1 illustrates some preferred materials for use in an injection-molding process to form the wax or wax-like shells. While the 10% paraffin wax could be used to form the shells via injection molding, the resulting shell still required that a plastic, inner shell be inserted to strengthen the outer shell, which results in additional expense and time to assemble. Advantageously, three wax-polymer blends were discovered (shown as rows C, D and E), which eliminated the need for an inner, plastic shell due to their structural hardness but maintained a desired waxy feel. These blends each included ELVAX™ and EPOLENE™ N35, which is a polyethylene (PE) homopolymer powder that was melt blended with natural or synthetic wax to increase the overall tensile strength of the wax blends.

The key attributes for an injection molding substitute is a sufficient shore hardness to eliminate the need for an internal plastic shell, a waxy feel of the shell, and a service temperature near that of Acrylonitrile Butadiene Styrene (ABS) plastic. It is also critical that the melting temperature of the wax and co-polymer are matched to ensure proper melting before the shell is molded.

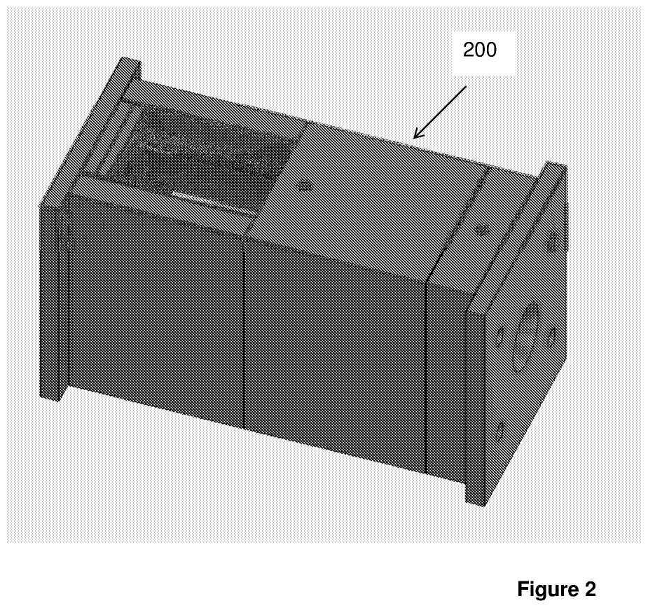

The wax shells are preferred created in an injection molding process, which can significantly reduce the overall cost of the component when compared with the traditional manufacturing process. An exemplary machine 200 that can be used in the injection molding process is shown in FIG. 2. The materials to be injected into the mold are preferably heated and mixed via one or more traditional methods, such as a screw based loader with heating elements along a length of the screw. Machine 200 preferably includes a spring loaded shut off valve to ensure the material(s) will not leak between cycles, as the material(s) generally have a lower viscosity than plastics and will leak from the machine. It is also contemplated that the machine could include cooling lines in the cavity to decrease cooling time for the mold.

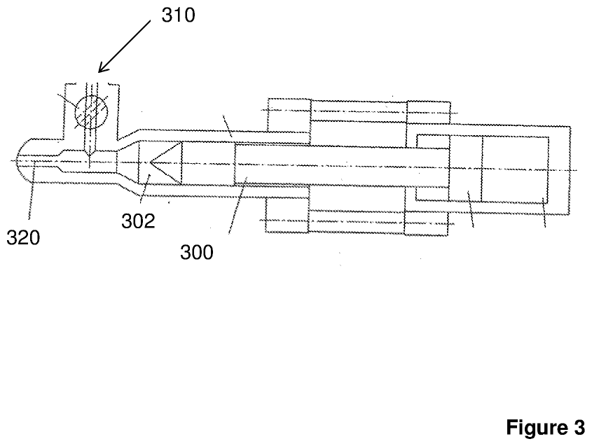

Once heated, the mixture is preferably injected into the mold via a plunger 300 through outlet 320, such as shown in FIG. 3. Such apparatus could include, for example, a plunger-based structural foam machine. The heated material(s) can be inserted into the plunger cavity via inlet 310 and then pushed through outlet 320 as the plunger head moves within the cavity (e.g., to the left). This process can be repeated for each mold to be produced. The injection molding machine and machine for heating the mixture is preferably water-tight to prevent leakage of the mixture once melted due its low viscosity.

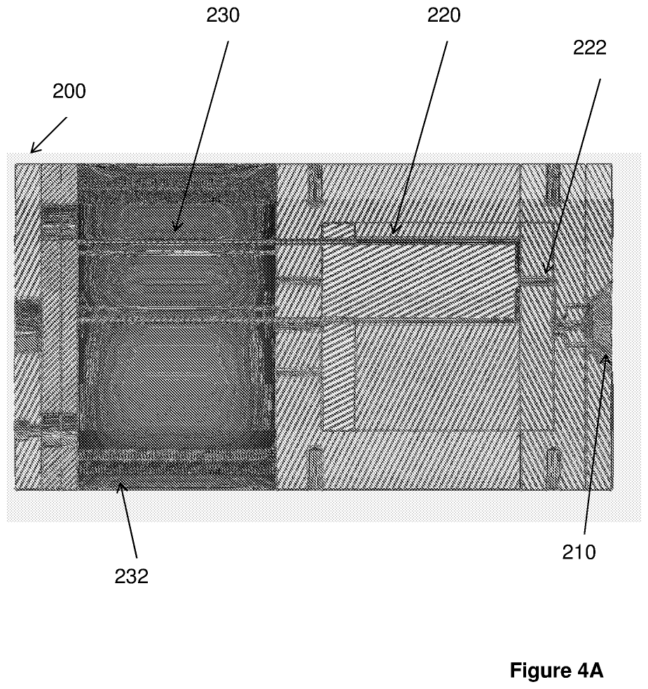

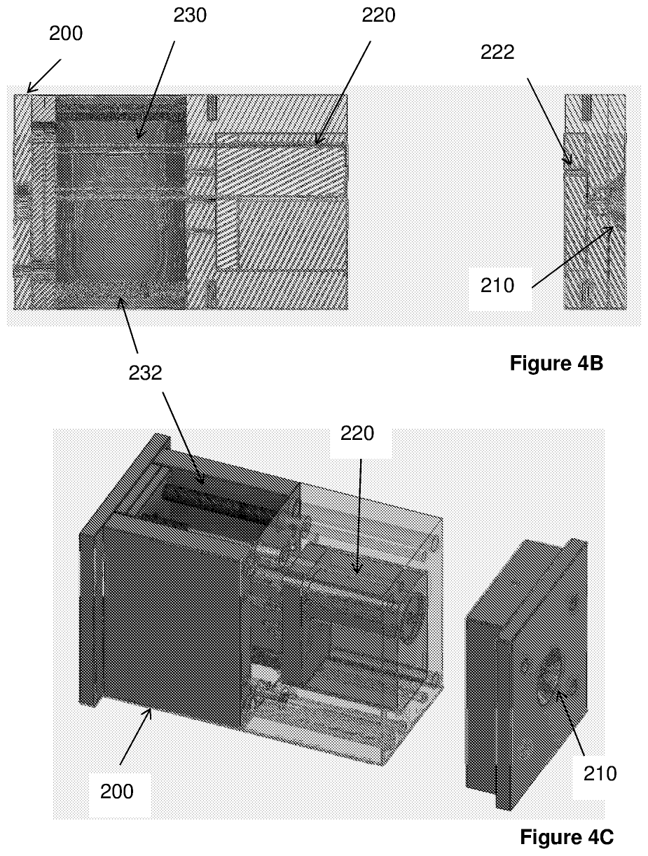

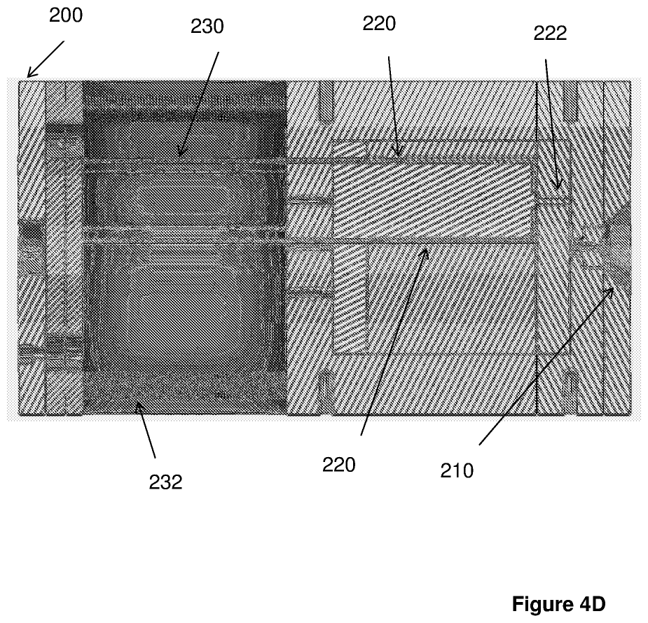

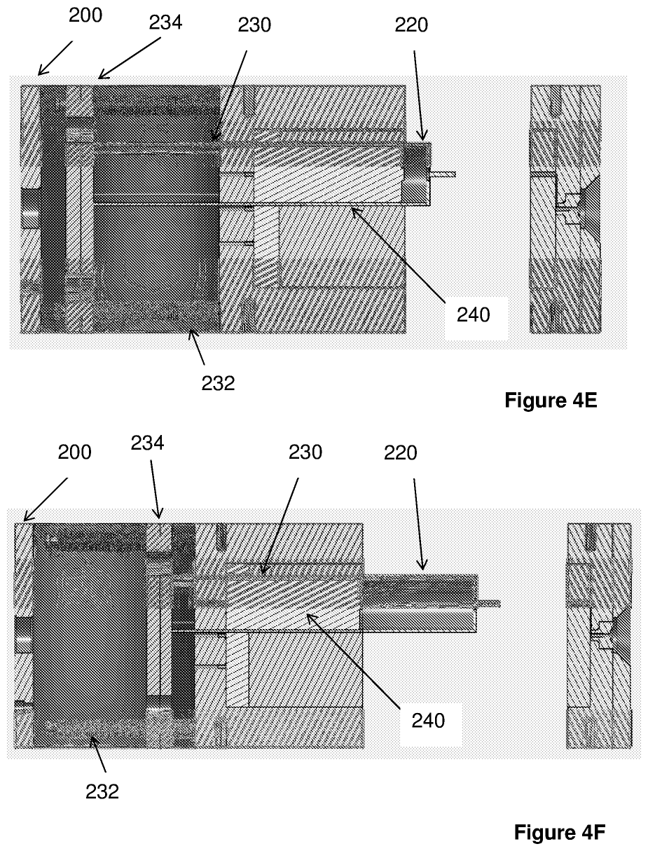

FIG. 4A illustrates a cross-sectional view of the machine 200 shown in FIG. 2. The machine 200 comprises an inlet 210 through which heated material can flow through a channel, through the inlet 222 of the mold and into the mold 200. A screw can be used to advance and retract the mold from the opposite side of the machine 200. The machine 200 further includes a sleeve 230 that can be advanced to push out the mold once cooled, and then retracted to allow the process to start over.

FIG. 4B illustrates the machine 200 in an initial position, where the mold is separated from the channel through which the heated material(s) flow. FIG. 4C illustrates the machine 200 beginning to close as the screws are rotated or other mechanism is used to move the pieces of the machine. FIG. 4D shows the machine in a closed position and material being injected through the inlet 210 into the mold 220, which is formed by a cylindrical block that creates a cavity between an exterior of the mold and the cylindrical block. It is this portion that fills with the injected material(s) and becomes the mold when cooled.

Once the mold is cooled, the mold 220 can be injected from the machine by advancing the cylindrical sleeve (to the right as shown in the FIGS. 4E and 4F). This is accomplished by rotation of screws 232, which causes platform 234 to move thereby moving the sleeve 230. When the sleeve 230 is almost or fully extended through the cavity, the mold 220 is ejected. As shown in the Figures, the mold 220 is hollow due to the presence of cylindrical block 240.

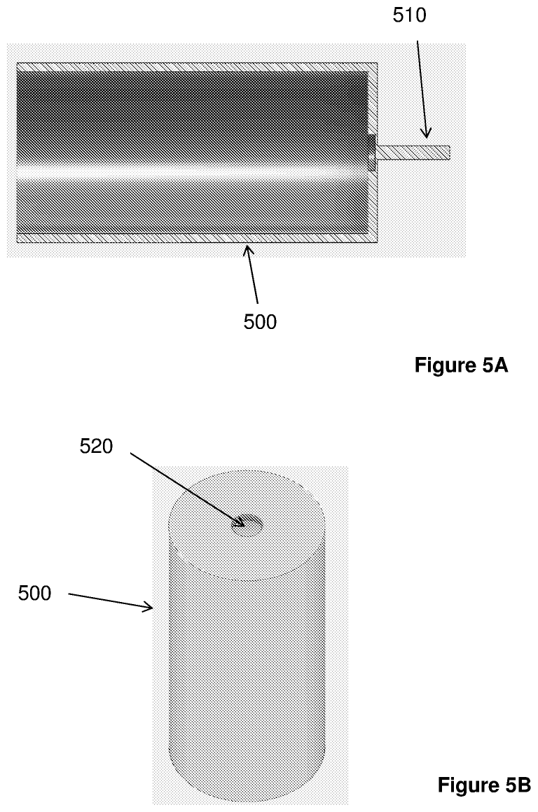

FIGS. 5A-5B illustrates one embodiment of a wax shell 500 produced via the injection molding process described above. Although the shell 500 has a cylindrical body with a flat top, it is contemplated that the process and machine described herein could be used to form differently shaped shells that could include scalloped or other forms at a top portion of the shell. In some embodiments, the molded shell 500 includes a runner 510 (shown in FIG. 5A) that needs to be snapped off or otherwise separated from the shell 500 to create an opening 520 in the top of the shell 500 (shown in FIG. 5B), such as for a moving flame member and/or to allow light to shine through the hole.

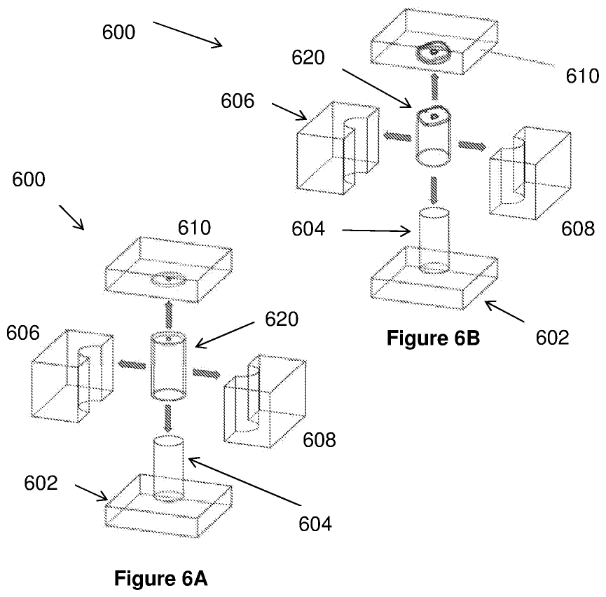

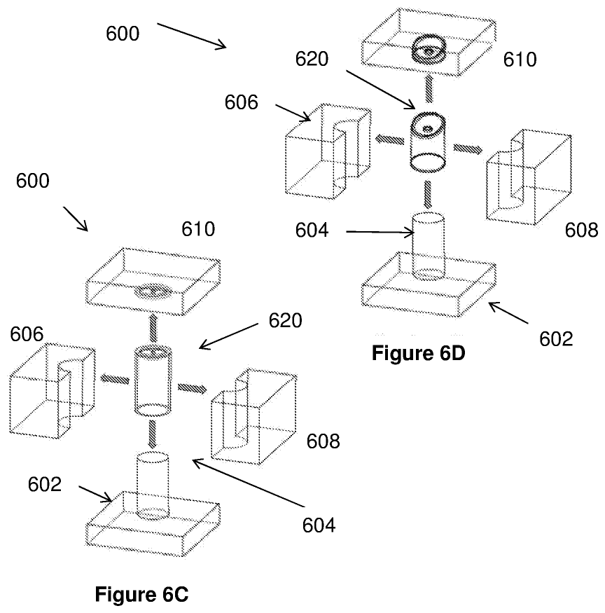

Another embodiment of a machine 600 for injection molding of a wax or wax-like shell is shown in FIGS. 6A-6D. In each of the embodiments, the mold comprises a bottom portion 602, a left side portion 606, a right side portion 608, and a top portion 610. Each of the portions are configured to be movable with respect to each other such that they can all come together to form the mold, and separating to release the mold or wax shell 620 once created. Various top portions can be used to change the top surface of the mold 620. For example, in FIG. 6A, the top portion can create a mold 620 with a flat top. The top portion of FIG. 6B can create a mold 620 with a scalloped top. The top portion of FIG. 6C can create a mold 620 with a stepped top. The top portion of FIG. 6D can create a mold 620 with a different scalloped top.

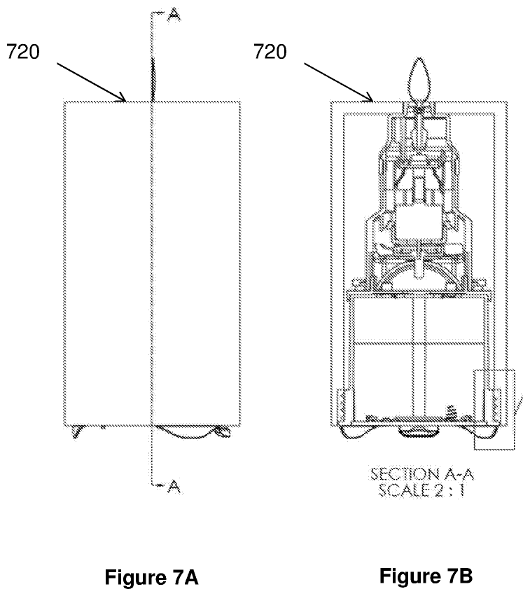

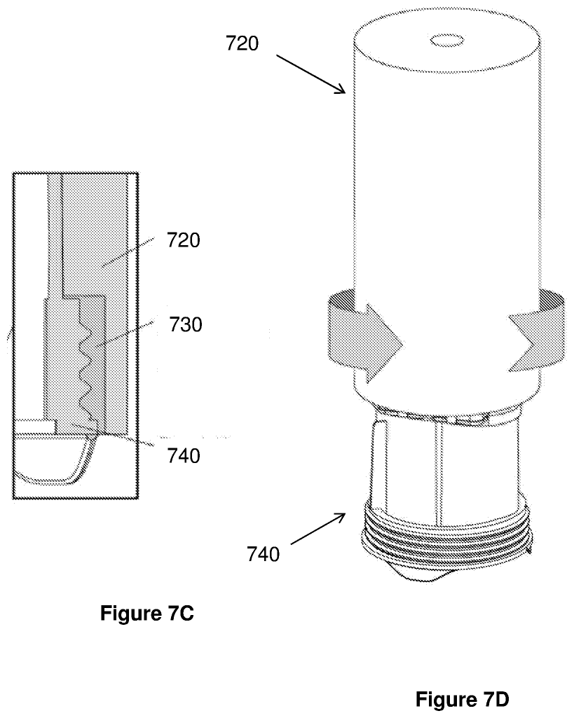

As shown in FIGS. 7A-7D, it is contemplated that the shell 720 can be formed via a co-insertion injection molding process, in which a ring or other insert 730 can be placed within the mold and the material injected into the cavity and about the ring or other insert 730 to form a single piece with the insert 730 embedded into the mold or shell 720. This advantageously eliminates the need for a separate plastic piece that can be used to receive a battery compartment or other components 740 of an electric candle, for example. As shown in FIG. 7B, the ring 730 may include threads such that internal components of the candle can be coupled to the shell 720 by coupling the two via the threads. This is shown in FIGS. 7C-7D.

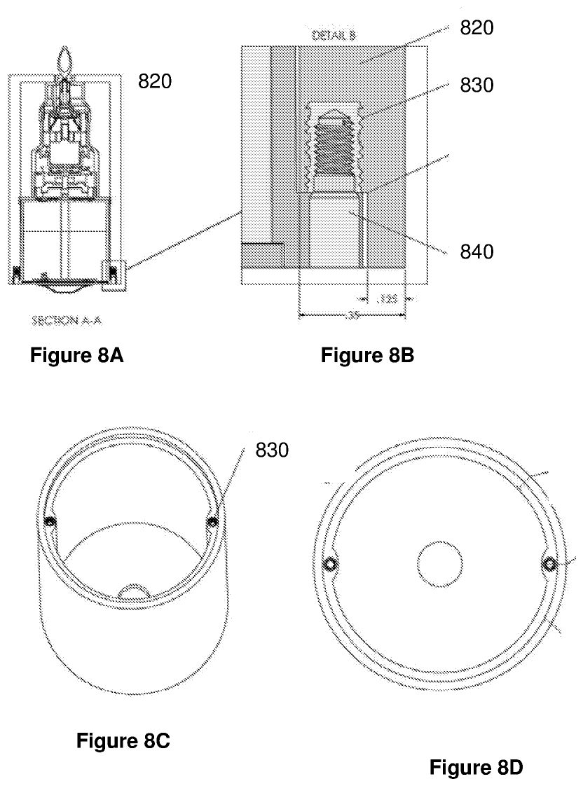

FIGS. 8A-8D illustrate an alternative embodiment for a co-injection molded shell 820 that includes a threaded insert 830 molded into the shell 820. It is contemplated that the injection molded shell can include a step at the bottom of the shell 820 to allow the internal components 840 to fit flush with the bottom of shell 820 when the internal components 840 are attached to the shell 820.

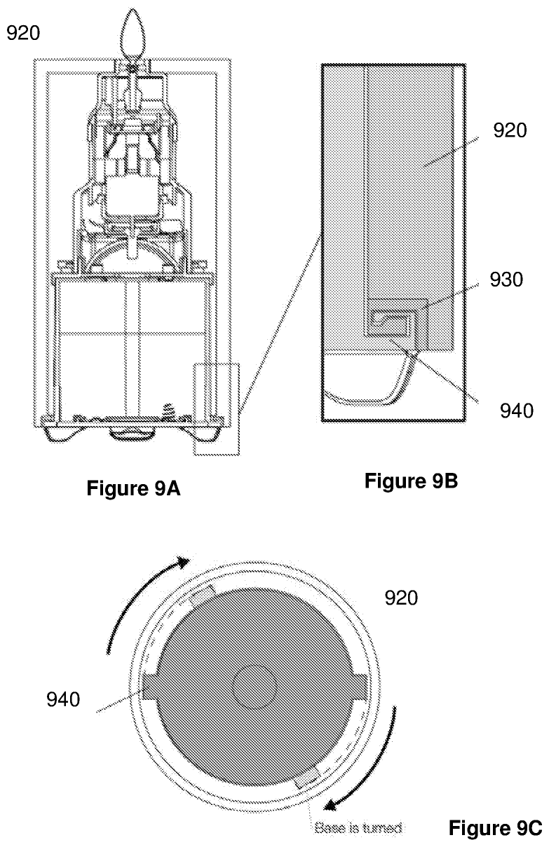

FIGS. 9A-9C illustrate an alternative embodiment for a co-injection molded shell 920 that includes a threaded insert 930 comprising a slider that allows the internal components 940 of the candle to be secured to the shell 920 by inserting it through a keyhole and then rotating the components 940 with respect to the shell 920.

Various homopolymers that are medium to low molecular weight polyethylene or polypropylene polymers were tested in the examples below including various EPOLENE™ polymers such as C13, C17, N35, and N10, all of which are produced by Westlake Chemical™ Corporation.

Epolene C13 and C17 are branched low density polyethylene homopolymers with low color and medium molecular weight. Coatings produced with Epolene C13 and C17 exhibit high gloss, low moisture vapor transmission rates, grease resistance, and good heat seal ability. C13 and C17 also have similar melting points (e.g., approx. 240° F.) and characteristics of Polyethylene. The viscosity of C13 based on its melt index at 190° C. and a 2.16 kg weight is 190. The viscosity of C17 based on its melt index at 190° C. and a 2.16 kg weight is 19, and is solid at 125° C. The Epolene homopolymers tested improved the performance of paraffin wax in candles, including longer burning times, improved gloss, opacity and sheen, increased hardness, higher tensile strength, nontoxicity and easy to blend.

Epolene N10 and N35 are polyethylene (PE) homopolymers that can conveniently be melt blended with natural or synthetic waxes to increase the tensile strength of wax blends, improve the gloss of paper coatings, aid in pigment dispersion and mold release, and improve scuff and rub off resistance in printing inks. However, Epolene N10 and N35 have similar properties to paraffin wax and have low melting temperatures (e.g., approx. 150° F.), which make them difficult to injection mold. The viscosity of N10 based on its melt index at 125° C. is 1,500 centipoise (cP). The viscosity of N35 based on its melt index at 125° C. is 700 cP.

### EXAMPLE 1

The mold here was created using an ARBURG 420M/allrounder 1000-250 Injection molding machine. The tool comprised a 3in×4 in cylindrical body with a flat top and a wall thickness of 0.1875 in.

The materials tested include DUPONT™ ELVAX™ 250 and 240W resins. ELVAX 250 and 240W are ethylene-vinyl acetate copolymer resins. The 240W also includes a “W” amide additive to improve pellet handling. N35 polymer and paraffin wax were also tested.

The first test attempted to create a mold using a 1:1 ratio of ELVAX 250 and paraffin wax. The two materials did not mix at the temperature set forth above. Instead, the wax became liquid and began dripping from the nozzle. Molding condition utilized are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 160 |
| Air temp. (° F.) | 65 |

The second test attempted to create a mold using 100% Paraffin wax. The paraffin completely filled the tool because of the reduced wall thickness. Two samples were shot at 140-150° F. However, the surface texture of the paraffin was poor due to the hot wax being shot into a cold mold. It is contemplated that heating lines could be used to improve the texture of the mold. Molding condition are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 140-150 |
| Air temp. (° F.) | 65 |

The next test attempted to create a mold using a mixture of 10% ELVAX 250 resin and 90% N35 resin. The two materials were successful in mixing and molding. Four samples were shot at temperatures ranging from 145-190° F. with the preferred temperatures being between 170-180° F. The samples revealed a wax-like texture that was softer than the 100% N35 samples. The added texture to the mold was also successful in reducing the glossiness of the samples. The molding condition are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 145-190 |
| Air temp. (° F.) | 65 |

The next test attempted to create a mold using a mixture of 30% ELVAX 250 resin and 70% N35 polymer. The samples had a slightly rubberier feel but were similar to the 10% ELVAX 250 resin samples. The molding condition are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 170-190 |
| Air temp. (° F.) | 2400 |

The next test attempted to create a mold using a mixture of 10% ELVAX 240W resin and 90% N35 polymer. This produced a rubber-like texture on the samples. The molding condition are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 170-190 |
| Air temp. (° F.) | 2400 |

The next test attempted to create a mold using a mixture of 30% ELVAX 240W resin and 70% N35 polymer. This resulted in a wax-like feel with less gloss and a texture more like rubber. The molding condition are shown below.

| | |
|---|---|
| Screw Back Pressure (PSI) | 2400 |
| Screw rotation speed (Ft/min) | 80 |
| Injection pressure (PSI) | 9000 |
| Cycle time (Sec) | 90 |
| Injection speed (In/sec) | 8 |
| Mold temp. (° F.) | 65 |
| Nozzle temp. (° F.) | 170-190 |
| Air temp. (° F.) | 2400 |

Based on the above experiments, the inventors discovered that reducing the wall thickness of the tool allowed for greater success in molding full parts. Adding texture to the tool reduced the glossiness of the samples. Water lines could be added to the cavity to facilitate the paraffin wax molding and improve the surface finish. The attributes of the various molds are shown below. The addition of the N35 polymer significantly increased the shore hardness of the sample.

| | Melting Point (° F.) | Shore Hardness (A) |
|---|---|---|
| High MP Paraffin | 160 | 89 |
| Elvax 240W | 165 | 73 |
| Elvax 250 | 158 | 80 |
| Pillar Candle | | 75-85 |
| N35 | 165+ | 100 |
| 10% Elvax 250 90% N35 | | 97 |
| 10% Elvax 240W 90% N35 | | 96 |
| 30% Elvax 250 70% N35 | | 96 |
| 30% Elvax 240W 70% N35 | | 95 |

### EXAMPLE 2

In this example, a sample molded of a 1:1 mixture of paraffin wax and ELVAX 250 resin displayed an inconsistency in the combination of the two materials because the resin did not completely mix with the paraffin wax before it was shot into the mold. This resulted from the dry mixed pellets failing to reach a temperature at which they become miscible with each other. After determining that the ELVAX 250 and ELVAX 240W resins containing 18-20% Ethylene vinyl acetate are both compatible and miscible with the paraffin wax, the inventors discovered that the problem was the dry mixing in the molding machine.

To alleviate this problem, the materials were compounded prior to being heated in the machine. Compounding is a process of melt blending plastics with other additives, and can change the physical, thermal, electrical or aesthetic characteristics of a plastic. Resin and additive(s) can be fed through an extruder where they are combined with the melted compound exiting the extruder in strands. These strands are cooled and cut into pellets, which can then be used for injection molding. Using a compounded mixture of the paraffin wax and resin facilitates the injection molding process because the resulting compounded material has a higher melting temperature and higher tensile strength than the paraffin wax alone.

However, there are difficulties with compounding paraffin wax with plastics due to the low melting temperatures of paraffin wax. Also, paraffin wax can ignite and some machines cannot contain a low temperature of 150° F. where the paraffin wax becomes liquid.

Several compositions of Epolene polymers were injection molded using a pre-existing mold. Compositions formed by weighing out pellets of each material for each injection molded batch.

### EXAMPLE 2A

### 100% C13 Polymer

Observations: semi-soft, flexible, transparent in color, with a low surface lubricity. Injection molded similarly to polyethylene resulted in no problems during molding.

### EXAMPLE 2B

### 100% C17 Polymer

Observations: similar to the C13 polymer and is flexible, transparent in color, and a low surface lubricity. It also exhibited no problems during molding.

### EXAMPLE 2C

### 100% N35 Polymer

Observations: due to low melting point, complications arose during the injection molding process where it was unable to maintain the molding pressure and unable to completely fill the mold. The polymer was a very soft material having a high surface lubricity with the look and feel like wax. Due to the soft material, larger ejector pins are needed to ease release from mold.

### EXAMPLE 2D

### 100% N10 Polymer

Observations: due to low melting point, complications arose during the injection molding process where it was unable to maintain the molding pressure and unable to completely fill the mold and eject the shell from the mold. The polymer was a soft material having a high surface lubricity with the look and feel of wax.

Based on these tests, it was determined that there is no noticeable difference between the use of C13 and C17 polymers. However, of the wax-like materials N10 and N35 polymers, the soft material, N35 polymer, was preferred.

Next, the following compositions of C13 and N35 polymers were mixed:
90% C-13/10% N-35
80% C-13/20% N-35
70% C-13/30% N-35
60% C-13/40% N-35
50% C-13/50% N-35
40% C-13/60% N-35
30% C-13/70% N-35
20% C-13/80% N-35
10% C-13/90% N-35

Based on these mixtures, it was discovered that adding small amounts (e.g., 1-10%) of N35 polymer to the C13 polymer showed effects of softening the C13 polymer, allowing it to mold well.

Adding small amounts of C13 (e.g., 1-10%) to N35 was difficult to mold because of the low melting temp and the machine's inability to hold pressure while heating the materials.

### EXAMPLE 3

Three different molds were created using 100% N35 polymer, 100% paraffin wax, and a 1:1 ratio of N35 polymer to paraffin wax. The molding conditions are shown below. The tool comprises a 3″×4″ flat top cylinder with a wall thickness of 0.25 inch.

| | | Paraffin | 50/50 |
|---|---|---|---|
| | 100% N35 | Wax | N35 Paraffin |
| Screw Back Pressure (PSI) | 2400 | 2400 | 2400 |
| Screw rotation speed (Ft/min) | 80 | 80 | 80 |
| Injection pressure (PSI) | 9000 | 9000 | 9000 |
| Cycle time (Sec) | 90 | 90 | 90 |
| Injection speed (In/sec) | 8 | 8 | 8 |
| Mold temp. (° F.) | 65 | 65 | 65 |
| Nozzle temp. (° F.) | 190 | 120-130 | 140 |
| Air temp. (° F.) | 65 | 65 | 65 |

For the mold created using 100% N35 polymer, the tool was unable to be filled and could not create a sufficient backpressure to create the bold. Material also dripped from the end of the nozzle due to the lack of a spring stop. It is contemplated that if the wall thickness is reduced by 25%-30%, this will allow the machine to fill without being maximized.

For the mold created using 100% Paraffin wax, a sample was shot at 113° F. with a cooling time of 2 min. However, some areas of the mold contained dry pellets of wax that did not completely melt. Increasing the melt temperature to 120-130° F. resulting in the material melting but with a low viscosity such that the machine could not shoot the material and melted wax dripped from the end of the nozzle.

For the mold created using a 1:1 ratio of N35 polymer and paraffin wax, the two materials would not mix at the mold temperature of 140° F. The paraffin wax liquidized and began to drip from nozzle while the N35 polymer was not completely melted.

From the above testing, the inventors discovered that the barrel should be loaded and the wax allowed to sit for a few minutes to allow the temperature of the barrel to completely melt the paraffin wax, which would allow for a lower temperature to be used.

### EXAMPLE 4

This test utilized DUPONT ELVAX 250 and 240W resin, N35 polymer, and paraffin wax. Molding conditions are shown below.

| | 20% Paraffin, | | 20% Paraffin, | 20% Paraffin, |
|---|---|---|---|---|
| | 12% Elvax, | 100% | 40% N35, | 12% N35, |
| | 68% N35 | Paraffin | 40% Elvax | 68% Elvax |
| Screw Back | 2400 | 2400 | 2400 | 2400 |
| Pressure (PSI) | | | | |
| Screw rotation | 80 | 80 | 80 | 80 |
| speed (Ft/min) | | | | |
| Injection pressure | 9000 | 9000 | 9000 | 9000 |
| (PSI) | | | | |
| Cycle time (Sec) | 90 | 90 | 90 | 90 |
| Injection speed | 8 | 8 | 8 | 8 |
| (in/sec) | | | | |
| Mold temp. (° F.) | 87 | 88-90 | 87 | 78 |
| Nozzle temp. (° F.) | 190 | 150 front | 190 | 190 |
| | | 110 back | | |
| Air temp. (° F.) | 70 | 70 | 70 | 70 |

For the test using 20% paraffin wax, 12% ELVAX, and 68% N35 polymer, the mixture molded smoothly and evenly, although the paraffin failed to add the wax-like textured that was desired.

For the test using 20% paraffin wax, 68% ELVAX, and 12% N35 polymer, the sample had a rubbery feel. The mixture also molded smoothly and evenly.

For the test using 20% paraffin wax, 40% ELVAX, and 40% N35 polymer, the mixture had a low hardness similar to paraffin wax, but lacked sufficient paraffin for a wax feel. The material molded smoothly and had a nice surface finish.

For the test using 100% paraffin wax, heating the mold eliminated some of the poor surface finish that had previously been seen but small dimples appeared after the sample and core were ejected from the tool.

Based on the above, it appears that higher concentrations of paraffin wax are needed to provide the wax-like feel to the shell. In addition, it is critical that the mixtures have similar flow rates and viscosities to ensure proper molding.

### EXAMPLE 5

Based on previous trials, the inventors elected to compound more than 20% paraffin wax into the mixture, and the ELVAX 250 resin was replaced with ELVAX 350 resin.

A test was conducted using 60% paraffin wax, 20% N35 polymer, and 20% ELVAX resin, but was unsuccessful despite using several different temperatures and feeding speeds on the machine. Wax poured from the vent with un-melted N35 and ELVAX pellets. The inventor discovered that 60% paraffin was too much wax content to be properly extruded.

Next a mixture of 1:1 ratio of N35 polymer to ELVAX resin was compounded, but the resin began pouring from the vent. This resulted from the most viscous material not being properly mixed with the other material.

Next a mixture of 30% paraffin wax, 35% ELVAX resin, and 35% N35 polymer was successfully extruded.

Next a mixture of 30% paraffin wax was mixed with 67% N35 polymer and only 3% ELVAX resin. It was contemplated that with more of the N35 polymer, there might be less spit out from the vent of the softer materials. However, there was still spit out from the vent and difficulty getting the materials to extrude.

The next mixture removed all ELVAX resin, and used 10% paraffin wax and 90% N35 polymer. This resulted in successful extrusion.

Next, a mixture of 40% paraffin wax and 60% N35 polymer did not successfully extrude.

Based on the above, it appears the wax spent too much time through the extruder (thereby shooting from the vent) and the N35 polymer failed to spend enough time in the machine to melt completely and mix with the paraffin.

### EXAMPLE 6

In this example, various combinations of paraffin wax, ELVAX 350 resin and N35 polymer were combined. Molding conditions are shown below.

| | 30% Paraffin, | 30% Paraffin, | 10% |
|---|---|---|---|
| | 35% Elvax, | 67% N35, | Paraffin, |
| | 35% N35 | 3% Elvax | 90% N35 |
| Screw Back Pressure (PSI) | 2400 | 2400 | 2400 |
| Screw rotation (Ft/min) | 80 | 80 | 80 |
| Injection pressure (PSI) | 9000 | 9000 | 9000 |
| Cycle time (Sec) | 90 | 90 | 90 |
| Injection speed (In/sec) | 8 | 8 | 8 |
| Mold temp. (° F.) | 80 | 80 | 80 |
| Nozzle temp. (° F.) | 165-190 | 165-190 | 168-190 |
| Air temp. (° F.) | 70 | 70 | 70 |

For the sample using 30% Paraffin wax, 35% ELVAX resin, and 35% N35 polymer, the mixture molded smoothly and evenly but the paraffin wax did not add much to the properties of the mold. There was not a significant difference in the 30% as compared with than the 20% paraffin.

For the sample using 30% Paraffin wax, 3% ELVAX resin, and 67% N35 polymer, the sample felt more similar to wax than the previous mixture with a 1:1 ratio of N35 and Elvax, but there was not a significant increase in wax feel with the 30% as compared with than the 20% paraffin.

For the sample using 10% Paraffin wax and 90% N35 polymer, the sample had a close feel to wax.

Conclusions: extruding the materials through a twin screw machine is not helpful as the paraffin spends too long in the extruder and is pushed out the vent while the plastic is not melted and mixed with the paraffin. The inventor believe that feeding the paraffin wax into the extruder after the plastics have been melted could solve this problem.

### EXAMPLE 7

In this example, various combinations of paraffin wax, microcrystalline wax, synthetic wax, and blends of N35 polymer were used to observe molding performance and conditions. Microcrystalline wax is a refined mixture of solid, saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). As a result the crystal structure of microcrystalline wax is much finer than paraffin wax, and this directly impacts many of the physical properties. Microcrystalline waxes are tougher, more flexible and generally higher in melting point than paraffin wax.

IRM Synthetic waxes are produced by the Fischer-Tropsch process. This process converts natural gas, coal or other carbon rich stock into long chain paraffins. They consist mainly of saturated, long straight-chain hydrocarbons with only a small number of iso-alkanes (methyl branches). Their high linearity and sharp carbon distribution produce a narrow melt range, making these waxes highly versatile for wax formulation. The oil content of synthetic waxes is very low and consists mainly of short-chain paraffins.

The molding conditions are shown below.

| | | | | IRM | 50/50 |
|---|---|---|---|---|---|
| | Paraffin | Micro- | 80% Paraffin | wax | paraffin |
| | wax | crystalline | 20% N35 | 190M | N35 |
| Screw Back Pressure | 2400 | 2400 | 2400 | 2400 | 2400 |
| (PSI) | | | | | |
| Screw rotation speed | 80 | 80 | 80 | 80 | 80 |
| (Ft/min) | | | | | |
| Injection pressure (PSI) | 9000 | 9000 | 9000 | 9000 | 9000 |
| Cycle time (Sec) | 90 | 90 | 90 | 90 | 90 |
| Injection speed (In/sec) | 8 | 8 | 8 | 8 | 8 |
| Mold temp. (° F.) | 86-87 | a)90 | 79 | 79 | 79 |
| | | b)87 | | | |
| | | c)79 | | | |
| Nozzle temp. (° F.) | a) 100-160 | a) 110-150 | 135-175 | 165-170 | 135-175 |
| | b) 100-140 | b) 115-155 | | | |
| Air temp. (° F.) | 80 | 80 | 80 | 80 | 80 |

For the 100% paraffin wax sample, several issues arose. Prior test showed a layer on the surface believed to be caused by the mold release used on the core and cavity of the tool to ease the release of the part from the tool. The appearance was small blisters/bubbles on the outside surface of the part. However, this test had no mold release but the blisters still appeared and the surface finish of the part was poor.

For the 100% microcrystalline wax sample, the wax molded with ease compared to the paraffin wax sample. There was minor blistering, but a smooth surface finish.

The 1:1 ratio of paraffin wax to N35 polymer was compounded. The resulting mold had a plastic feel that was very hard and glossy, and cracked on release from the tool.

For the 80% Paraffin wax and 20% N35 polymer mixture, the material was compounded and the samples were harder than expected. They had a wax like texture, but were very glossy and a little less hard than the 50/50 blend above.

For the synthetic wax (IRMwax 190M), the samples were very hard and molded nicely with minor blistering, but the wax felt similar to plastic.

Conclusions: based on the above test, the synthetic wax proved to be too hard, but the microcrystalline was a close match to traditional wax.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for forming a shell for an electric candle, comprising:
providing an injection molding machine having a cavity into which material can be injected to create a mold;
injecting a mixture into the cavity that comprises wax and a polymer to form the mold; and
releasing the shell from the tool by advancing a sleeve toward the shell.

2. The method of claim 1, wherein the mixture is compounded prior to being melted.

3. The method of claim 1, wherein the mixture comprises between 40%-90% of the polymer relative to the wax.

4. The method of claim 1, wherein the wax comprises a microcrystalline wax.

5. The method of claim 1, wherein the polymer comprises a polyethylene (PE) homopolymer.

6. The method of claim 5, wherein the polymer comprises EPOLENE N35 polymer.

7. The method of claim 1, wherein the mixture further comprises an ethylene-vinyl acetate copolymer resin.

8. The method of claim 1, wherein the sleeve is cylindrical and configured to be inserted into the cavity to push out the mold from the cavity when cooled.

9. An injection molding tool for creating wax or wax-like shells for use in electric candles, comprising:
a bottom piece;
left and right side pieces;
a top piece;
wherein the bottom piece, top piece, and left and right side pieces are configured to abut one another to form a cavity configured to receive a material via injection molding to form a mold; and
wherein the mold is released after the pieces are separated from one another.

10. The method of claim 9, wherein the shell mold an insert that is molded into the mold.

11. The method of claim 10, further comprising placing the insert into the tool, and wherein the step of injecting the material further comprises injecting the material into the cavity and around the insert.

12. The method of claim 9, wherein the top piece is modular such that different top pieces can be used to vary an upper surface of the mold.

13. A composition for use in injection molding of a wax or wax-like shell, comprising:
a wax or ethylene-vinyl acetate copolymer resin; and
a polyethylene (PE) homopolymer having a concentration of between 40% -90%.

14. The composition of claim 13, further comprising the wax and the ethylene-vinyl acetate copolymer resin.

15. The composition of claim 14, wherein the ethylene-vinyl acetate copolymer resin has a concentration of between 10%-50%.

16. The composition of claim 13, comprising a mixture of between 5-15% ethylene-vinyl acetate copolymer resin and 85-95% polyethylene homopolymer.

17. The composition of claim 13, comprising a mixture of between 25-35% ethylene-vinyl acetate copolymer resin and 65-75% polyethylene homopolymer.

18. The composition of claim 13, comprising a mixture of between 15-25% paraffin wax, 35-45% ethylene-vinyl acetate copolymer resin and 30-50% polyethylene homopolymer.
